(19) United States
(12) Patent Application Publication
(10) Pub. No.: US 2011/0317410 A1
(43) Pub. Date: Dec. 29, 2011

(54) LED ILLUMINATING APPARATUS

(75) Inventors: Ai-Ko HUANG, Chu-Nan (TW); Hsin-Mei MO, Chu-Nan (TW)

(73) Assignee: FOXSEMICON INTEGRATED TECHNOLOGY, INC., Chu-Nan (TW)

(21) Appl. No.: 12/852,529

(22) Filed: Aug. 9, 2010

(30) Foreign Application Priority Data
Jun. 23, 2010 (TW) 99120359

(51) Int. Cl. F21S 4/00; F21V 7/00

(52) U.S. Cl. 362/225; 362/235

(57) ABSTRACT

An LED illuminating apparatus includes a substrate, an envelope facing to the substrate, and at least one LED arranged on the substrate. The substrate includes a first surface. The first surface includes an installed surface and a convex surface connected to the installed surface. The envelope includes a light emitting portion faces to the first surface of the substrate. The at least one LED is arranged on the installed surface of the substrate. A part of light emitted from the at least one LED is reflected by the convex surface of first surface of the substrate, and travels through the envelope to an outside.

### BACKGROUND

1. Technical Field

The present disclosure generally relates to an LED illuminating apparatus, and more particularly to an LED illuminating apparatus used as a wall washer which can adjust light emitted from light source to a predeterminate position.

2. Discussion of Related Art

Light emitting diodes (LEDs) are one kind of semiconductor element. Nowadays, LEDs are extensively used as light sources for illuminating apparatuses, due to their high luminous efficiency, low power consumption and long work life.

Conventional tubular LED illuminating apparatus incorporating LEDs generally generate butterfly-type light fields or have a radiation angle about 120 degrees. However, this type of light field is not suitable for illuminating a wall, because part of light can not illuminate the wall thereby being wasted.

Therefore, what is needed is an LED illuminating apparatus which can overcome the above described shortcomings

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled view of an LED illumination apparatus in accordance with a first embodiment of the present disclosure.

FIG. 2 is an exploded view of the LED illumination apparatus of FIG. 1.

FIG. 3 is a cross-sectional view of the LED illumination apparatus of FIG. 1, taken along line thereof.

FIG. 4 is an assembled view of an LED illumination apparatus in accordance with a second embodiment of the present disclosure.

FIG. 5 is an exploded view of the LED illumination apparatus of FIG. 4.

FIG. 6 is a cross-sectional view of the LED illumination apparatus of FIG. 4, taken along line VI-VI thereof.

### DETAILED DESCRIPTION OF EMBODIMENTS

Reference will now be made to the drawings to describe various embodiments of the present LED illuminating apparatus in detail.

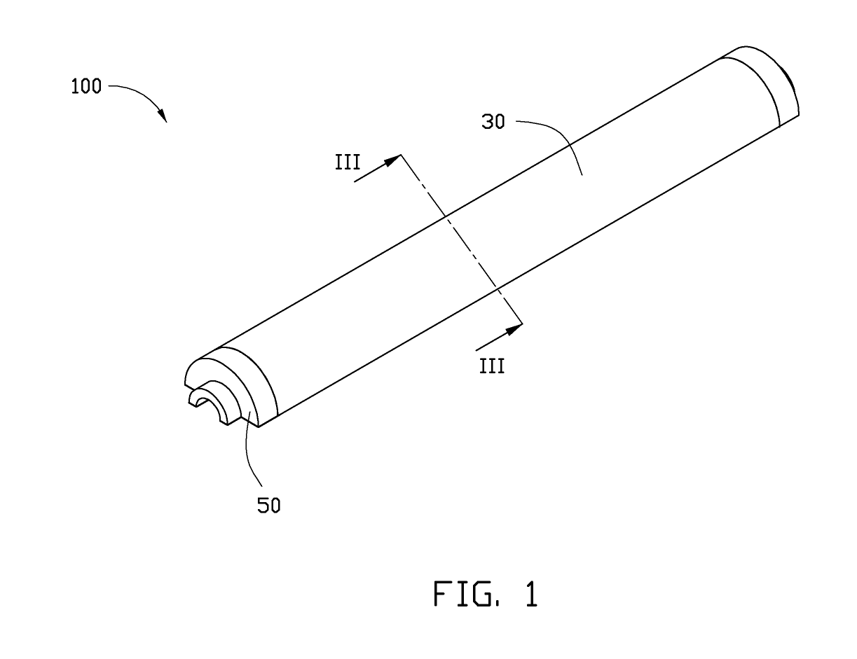

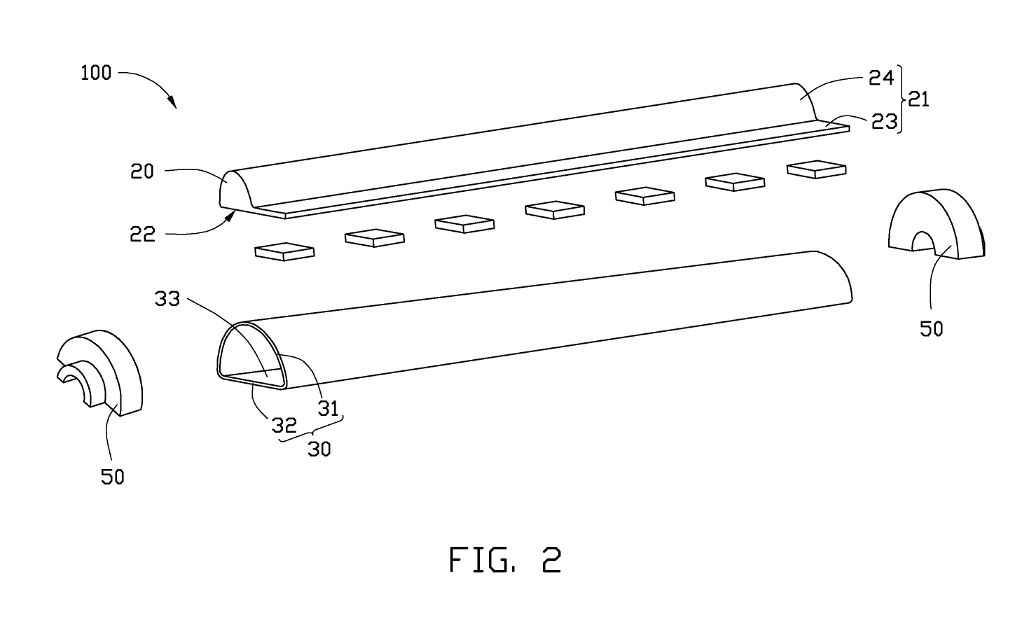

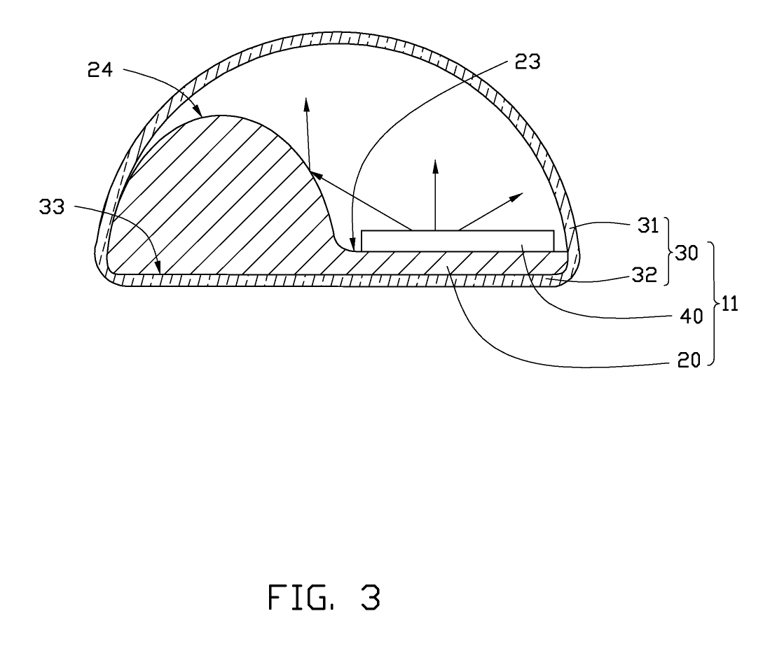

Referring to FIGS. 1-3, an LED illuminating apparatus 100, in accordance with a first embodiment, which is an LED light tube, includes an LED module 11 and two connectors 50 secured at two opposite ends of the LED module 11. The LED module 11 includes a substrate 20, an envelope 30, and a plurality of LEDs 40.

The substrate 20 has a first surface 21 and an opposite second surface 22.

The first surface 21 includes an installed surface 23 and a convex surface 24 connected to the installed surface 23. In the present embodiment, the installed surface 23 is a flat surface. The convex surface 24 has a semi-cylindrical shape. The second surface 22 is a flat surface. It can be understood that the convex surface 24 may be in a semi-elliptical shape, and the installed surface 23 may be in a shape of arc in an alternative embodiment. In the present embodiment, the substrate 20 is made of metal which has a high thermal conductivity and high reflectivity, such as copper, aluminum, or stainless steel. Alternatively, the substrate 20 can be made of other material which with lower reflectivity, such as plastic, or resin, and coated with a reflective material thereon.

The LEDs 40 are evenly arranged on the installed surface 23 of the first surface 21 of the substrate 20 along a lengthwise direction of the substrate 20. Each LED 40 is mounted in a thermally conductive relationship with the substrate 20. The LEDs 40 can be connected to each other by wire-bonding. It can be understood that there can be only one LED 40.

The envelope 30 includes a light emitting portion 31 and a supporting portion 32 connected to the light emitting portion 31. In the present embodiment, the light emitting portion 31 faces to the first surface 21 of the substrate 20. The light emitting portion 31 has an arc-shaped. The supporting portion 32 is planar, and has a supporting surface 33. The light emitting portion 31 and the supporting portion 32 cooperatively define a hollow semi-cylindrical cavity configured for receiving the substrate 20 therein. In the present embodiment, the second surface 22 of the substrate 20 is secured at the supporting surface 33 of the supporting portion 32. A part of light emitted from the LEDs 40 is reflected by the convex surface 24 of the substrate 20, and then travels through the envelope 30 to an outside of the LED illuminating apparatus 100 for lightening. Other part of light emitted from the LEDs 40 directly travels through the envelope 30 for lighting. The light emitting portion 31 is transparent or light pervious, such as glass, plastic, or other transparent/translucent material. In the present embodiment, the light emitting portion 31 is integrally formed with the supporting portion 32, and the light emitting portion 31 and the supporting portion 32 are made of glass. It can be understood that the supporting portion 32 can be made of metal, and used for dissipating heat generated by the LEDs 40.

The connectors 50 are secured at the two opposite ends of the envelope 30, and configured for covering the two open axial ends of the envelope 30. The connectors 50 are provided for connecting with an external power source via two sockets (not shown) of a lamp holder (not shown) whereby the LEDs 40 can obtain the required electrical power for generating light. The connectors 50 are electrically connected with the LEDs 40.

The LED illuminating apparatus 100 is generally secured on wall, and configured as a wall washer. In the present embodiment, the supporting portion 32 of the envelope 30 is secured at the wall, and the first surface 21 of the substrate 20 is far away from the wall. The convex surface 24 of the substrate 20 can reflect light emitted from LEDs 40 to the wall; therefore, it can improve the light utilization efficiency. It can be understood that the light emitted position can be changed via changing the radian of the convex surface 24. In the present embodiment, the substrate 20 is made of metal; therefore, heat generated by LEDs 40 is transferred to the substrate 20, and then dissipated to the environmental air. Therefore, a heat dissipating capability of the LED illuminating apparatus 100 will be improved.

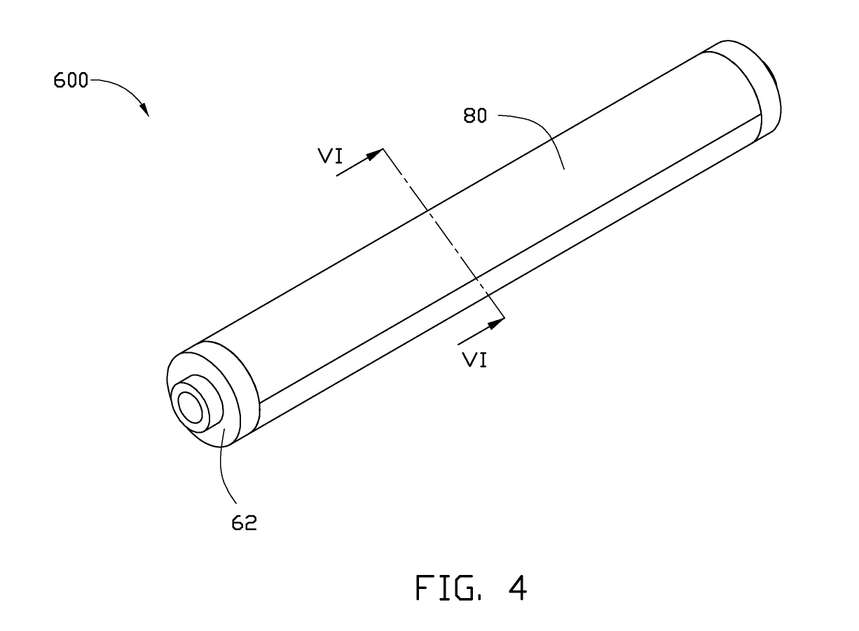

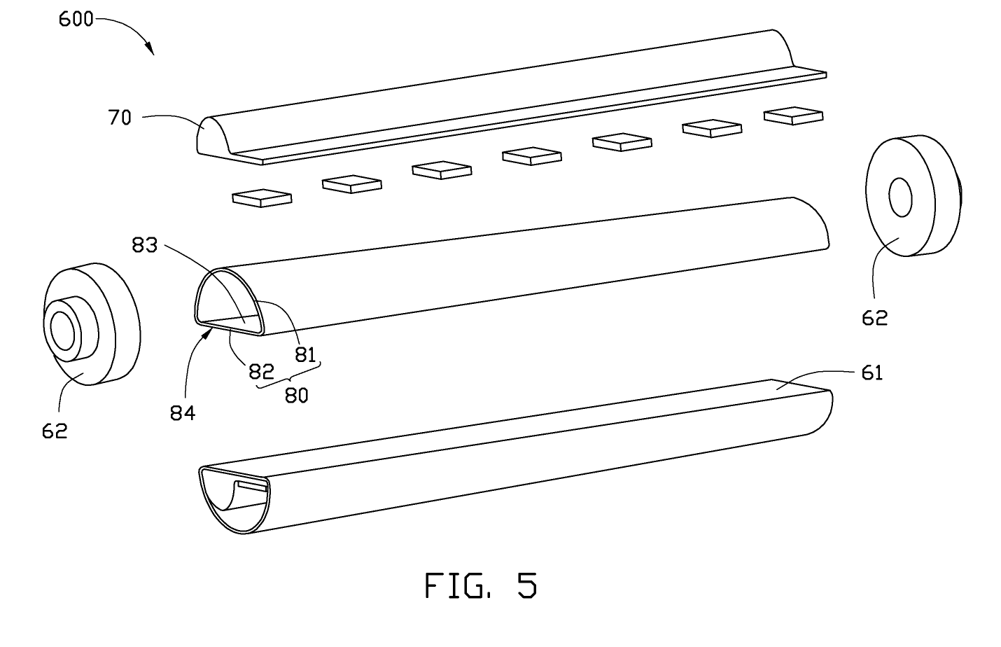

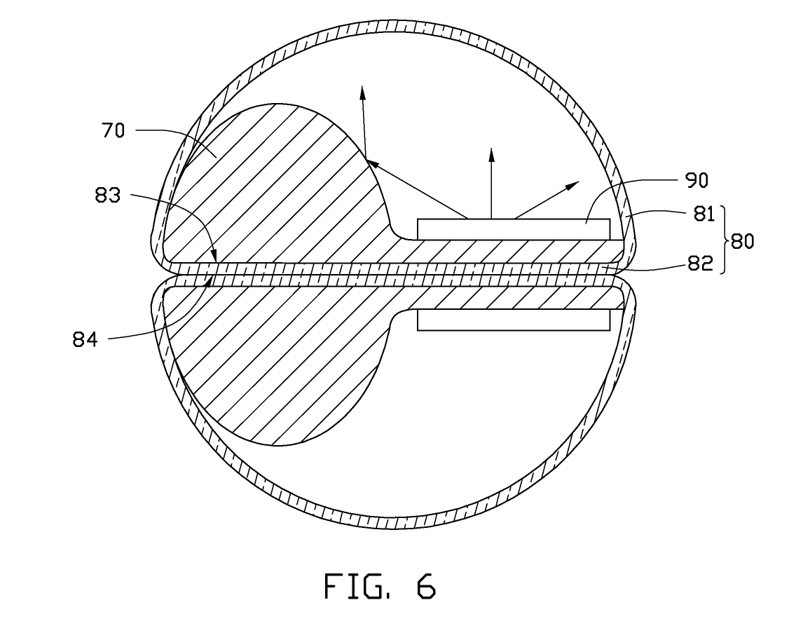

Referring to FIGS. 4-6, an LED illuminating apparatus 600, in accordance with a second embodiment, includes two LED modules 61 engaged with each other, and two connectors 62 secured at two opposite ends of the LED modules 61. Each LED module 61 is similar to the LED module 11 of the first embodiment. Each of the LED modules 61 includes a substrate 70, an envelope 80, and a plurality of LEDs 90.

The envelope 80 includes a light emitting portion 81 and a supporting portion 82 connected to the light emitting portion 81. The light emitting portion 81 has a semi-cylindrical shape, and the supporting portion 82 is flat. The supporting portion 82 includes a supporting surface 83 and an opposite bottom surface 84. The light emitting portion 81 and the supporting portion 82 cooperatively define a hollow semi-cylindrical cavity configured for receiving the substrate 70 and the LEDs 90 therein.

In the present embodiment, a bottom surface 84 of one of the LED modules 61 faces and is adjacent to the bottom surface 84 of the other LED module 61, and the two connectors 62 secured at two opposite ends of the LED modules 61; therefore, the two LED modules 61 cooperatively define a cylindrical cavity. In the present embodiment, the LEDs 90 of each the LED module 61 are arranged on the same side of the LED illuminating apparatus 600.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A light emitting diode (LED) illuminating apparatus comprising:
a substrate comprising a first surface, the first surface having an installed surface and a convex surface connected to the installed surface;
an envelope comprising a light emitting portion facing to the first surface of the substrate; and
at least one LED arranged on the installed surface of the substrate, a part of light emitted from the at least one LED being reflected by the convex surface of the substrate, and then traveling through the envelope to an outside, other part of light emitted from the at least one LED directly travelling through the envelope for lighting.

2. The LED illuminating apparatus of claim 1, wherein the convex surface is a semi-cylindrical.

3. The LED illuminating apparatus of claim 1, wherein the envelope further comprises a supporting portion connected to the light emitting portion, the light emitting portion and the supporting portion cooperatively defining a hollow semi-cylindrical cavity configured for receiving the substrate therein.

4. The LED illuminating apparatus of claim 3, wherein the envelope is semi-cylindrical shape, and the substrate having a second surface opposite to the first surface, the second surface of the substrate being secured on the supporting portion of the envelope.

5. The LED illuminating apparatus of claim 1, wherein the light emitting portion of the envelope is arc-shaped.

6. The LED illuminating apparatus of claim 1, wherein the substrate is made of metal.

7. The LED illuminating apparatus of claim 1, wherein the installed surface of the substrate is flat, and the LED illuminating apparatus comprises a plurality of LEDs, the LEDs being arranged on the supporting surface in an array.

8. The LED illuminating apparatus of claim 1, further comprising two connectors, the connectors being secured at the two opposite ends of the envelope.

9. The LED illuminating apparatus of claim 1, wherein the convex surface of the substrate is coated with a reflective material thereon.

10. An LED illuminating apparatus comprising two LED modules, each LED module comprising:
a substrate comprising a first surface and an opposite second surface, the first surface comprising an installed surface and a convex surface connected to the installed surface;
an envelope comprising a light emitting portion facing to the first surface of the substrate;
at least one LED arranged on the installed surface of the substrate, a part of light emitted from the at least one LED being reflected by the convex surface of the substrate, and traveling through the envelope to an outside; and
a second surface of one of the LED module facing to a second surface of the other LED module, the at least one LED of each the LED module being arranged on the same side of the LED illuminating apparatus.

11. The LED illuminating apparatus of claim 10, wherein the envelope of each LED module further comprises a supporting portion connected to the light emitting portion, the light emitting portion and the supporting portion cooperatively defining a hollow semi-cylindrical cavity configured for receiving the substrate therein, the two supporting portions of the envelops of the two LED modules being connected to each other.

12. The LED illuminating apparatus of claim 11, wherein the light emitting portion of the envelope is an arc-shaped, the two envelopes cooperatively defining a cylindrical cavity.

13. The LED illuminating apparatus of claim 10, wherein the substrate is made of metal.

14. The LED illuminating apparatus of claim 10, wherein the convex surface of the substrate is coated with a reflective material thereon.
